(19) United States
(12) Patent Application Publication
(10) Pub. No.: US 2026/0368164 A1
(43) Pub. Date: Nov. 19, 2026

(54) MULTI-LEVEL CACHING OF LANGUAGE MODEL QUERIES

(71) Applicant: Dell Products L.P., Round Rock, TX (US)

(72) Inventors: Pankaj Pande, Carlingford (AU); Gaurav Chawla, Austin, TX (US)

(21) Appl. No.: 19/211,504

(22) Filed: May 19, 2025

(51) Int. Cl. G06F 16/2453

(52) U.S. Cl. CPC G06F 16/24539

(57) ABSTRACT

Techniques are provided for multi-level caching of language model queries. One method comprises determining a query-dependent value of a query; evaluating a similarity of the query relative to previous queries stored in a multi-level cache, wherein the multi-level cache comprises (i) a first level cache that stores a first plurality of previous queries, wherein a first-level similarity evaluation comprises performing a lookup in the first level cache using the query-dependent value and (ii) a second level cache that stores a second plurality of previous queries, wherein a second-level similarity evaluation comprises evaluating whether the query has a similarity score, with respect to the second plurality of previous queries, that satisfies designated similarity criteria; and generating a query response to the query, in response to the similarity evaluations determining that the query does not have a similar query stored in the multi-level cache, by applying the query to a language model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some artificial intelligence techniques are trained to answer various user queries (e.g., questions). As workloads for such artificial intelligence-based query-response techniques grow in complexity, repeated queries, often with subtle semantic variations, may cause system inefficiencies, increased latency and/or increased token costs.

### SUMMARY

Illustrative embodiments of the disclosure provide techniques for multi-level caching of language model queries. One method includes obtaining at least one query; determining a query-dependent value of the at least one query; evaluating a similarity of the at least one query relative to a plurality of previous queries stored in a multi-level cache, wherein the multi-level cache comprises at least (i) a first level cache that stores a first plurality of previous queries, wherein a first similarity evaluation of the first-level cache comprises performing a lookup in the first level cache using the query-dependent value; and (ii) a second level cache that stores a second plurality of previous queries, wherein a second similarity evaluation of the second-level cache comprises evaluating whether the at least one query has a similarity score, with respect to respective ones of the second plurality of previous queries, that satisfies one or more designated similarity criteria; and generating at least one query response to the at least one query, in response to the first and second similarity evaluations determining that the at least one query does not have a similar query stored in the multi-level cache, by applying the at least one query to at least one language model.

Illustrative embodiments can provide significant advantages relative to conventional techniques. For example, technical problems related to such conventional techniques are mitigated in one or more embodiments by using different similarity evaluations (e.g., exact similarity, semantic similarity and/or forecasted similarity) to retrieve previous queries from different levels of a multi-level cache.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for multi-level caching of language model queries in accordance with an illustrative embodiment;

FIG. 2 illustrates exemplary routing rules for a multi-level cache in accordance with an illustrative embodiment;

FIG. 3 is a flow diagram illustrating an exemplary implementation of a process for multi-level caching of language model queries in accordance with an illustrative embodiment;

FIGS. 4 and 5, collectively, comprise a process diagram illustrating an exemplary implementation of a process for multi-level cache response retrieval in accordance with an illustrative embodiment;

FIG. 6 is a process diagram illustrating an exemplary implementation of a multi-level cache hybrid query prefetch process in accordance with an illustrative embodiment;

FIG. 7 is a flow diagram illustrating an exemplary implementation of a process for multi-level caching of language model queries in accordance with an illustrative embodiment;

FIG. 8 illustrates an exemplary processing platform that may be used to implement at least a portion of one or more embodiments of the disclosure comprising a cloud infrastructure; and

FIG. 9 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for multi-level caching of language model queries.

Large scale artificial intelligence services may incur increasing costs and user-visible latency because user queries (e.g., user requests) are typically routed to a large language model (LLM) even when the answer (or a near duplicate answer) was already recently generated. Existing cache systems typically only identify byte-for-byte duplicates and cannot adapt to evolving phrasing or bursty traffic.

In one or more embodiments, the disclosed techniques for multi-level caching of language model queries employ three specialized, self-optimizing cache levels plus a hybrid pre-fetch engine driven by reinforcement learning (RL). For example, an RL controller may dynamically allocate storage resources among the multiple levels of the multi-level cache, as well as expiration values for queries cached in one or more levels of the multi-level cache. A level zero cache (e.g., an exact match cache) of the disclosed multi-level cache may cache frequently encountered queries and retrieve previous queries using a key lookup (such as a hash value lookup) to identify exact matches. A level one cache (e.g., a semantic vector-based similarity cache) of the disclosed multi-level cache may cache semantically indexed representations (e.g., vector embeddings) of previous queries and their responses (e.g., prior unique queries and corresponding responses mapped to dense embeddings), for example, and retrieve previous queries using a similarity search (e.g., a K-nearest neighbor (KNN) similarity and/or a cosine similarity) over query embeddings to identify semantically similar queries. For example, such entries are retrievable using an approximate nearest-neighbor (ANN) search based on one or more similarity metrics (e.g., cosine similarity).

A level two cache (e.g., a predictive preemptive cache) may employ a forecast to identify predicted high likelihood queries (e.g., anticipated queries, such as those queries related to upcoming sales) and may cache such high likelihood queries (and possibly corresponding responses). The level two cache may retrieve previous queries using a similarity search and may employ hybrid prefetching strategies that combine demand-driven prefetching and predictive prefetching (e.g., to optimize cache loading for various expected scenarios).

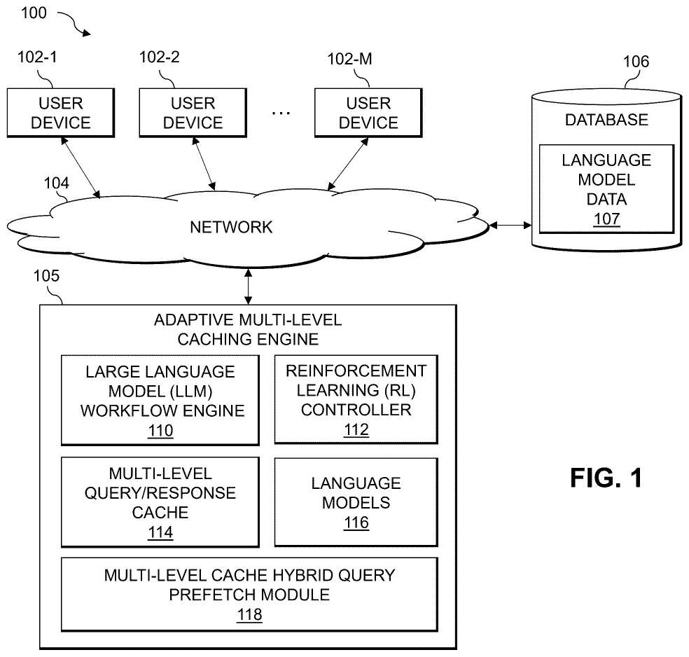

FIG. 1 shows an information processing system 100 configured in accordance with an illustrative embodiment. The information processing system 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger information processing system 100. Also coupled to network 104 is an adaptive multi-level caching engine 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

The adaptive multi-level caching engine 105 may comprise a large language model (LLM) workflow engine 110, an RL controller 112, a multi-level query/response cache 114, one or more language models 116 and a multi-level cache hybrid query prefetch module 118. The multi-level query/response cache 114 may selectively cache previous queries and/or query responses, as described below.

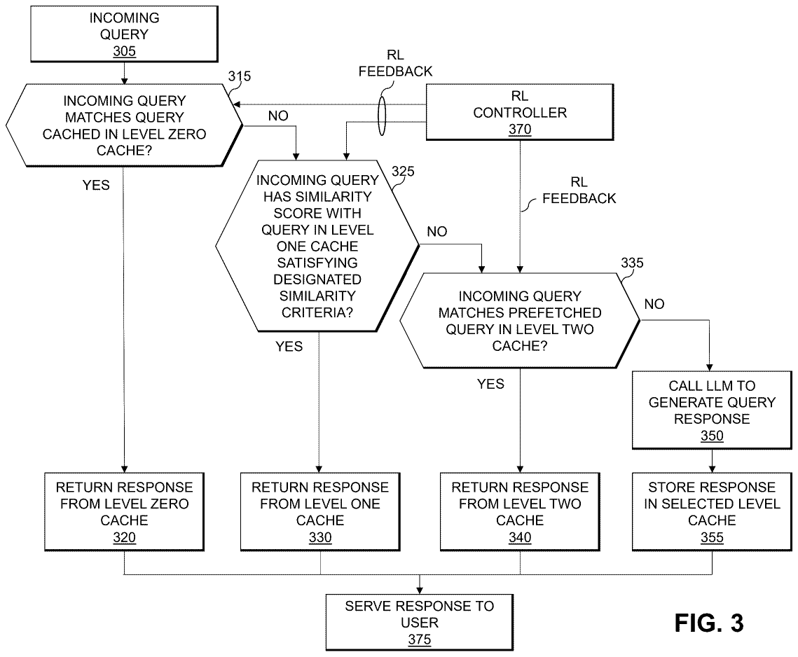

In one or more embodiments, new queries may be passed through the LLM workflow engine 110, which can generate a common word embedding vector in some embodiments for each query and perform other tasks for processing queries. A word embedding vector may be generated, for example, using an embedding method such as term frequency-inverse document frequency (TF-IDF), latent semantic analysis (LSA), GloVe, Word2Vec, etc. Once a given vector is generated, a hash of the vector may be created to be used as the unique identifier in a level zero cache of the multi-level query/response cache 114, as discussed further below in conjunction with FIG. 3, for example. This hash value may be used in some embodiments to query the multi-level query/response cache 114 to determine if the given query was previously processed, and if so, to retrieve the previous corresponding response from the cache. Such an embodiment can include precluding the expense of processing a new query through the language models 116 again for a query that has already been asked and processed.

If the query vector hash is not found in the level zero cache of the multi-level query/response cache 114, the LLM workflow engine 110 may initiate an evaluation of the similarity of a new query with respect to previously processed queries cached in a level one cache of the multi-level query/response cache 114, in relation to the new query, as discussed further below in conjunction with FIG. 3, for example.

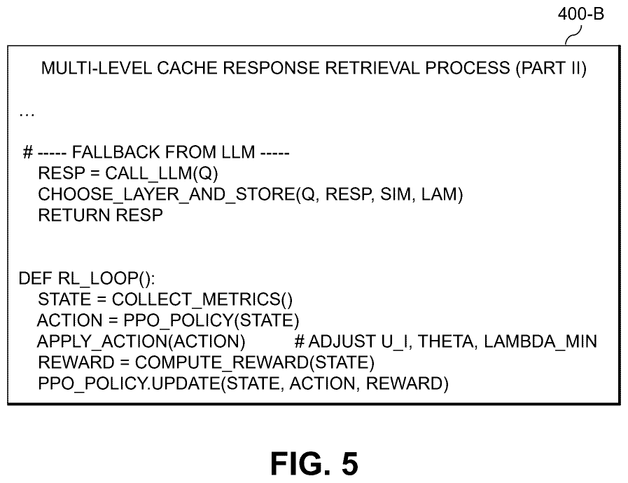

The RL controller 112 may update an allocation of storage resources among the various levels of the multi-level query/response cache 114 and update expiration values for various entries cached in the multi-level query/response cache 114, as discussed further below in conjunction with FIG. 5, for example.

The one or more language models 116 may comprise, for example, LLMs or other models that can generate text and perform natural language processing (NLP) tasks, that determine a response to a user of a respective user device 102, as discussed herein. The language models 116 may learn statistical relationships from a training dataset comprised of text documents using a self-supervised training process and/or a semi-supervised training process, for example.

The term “language model” as used herein is intended to be broadly construed so as to encompass, for example, natural language processing models trained on textual data to understand, generate, predict and/or summarize new content. The language models 116 may be implemented, for example, using transformer-based architectures that process input through a sequence of transformers, where each transformer includes a self-attention layer and a feedforward layer. Generally, the self-attention layer computes an importance of each token in a sequence of input tokens, and the feedforward layer transforms the output of the self-attention layer into a form that is suitable for the next transformer in the sequence.

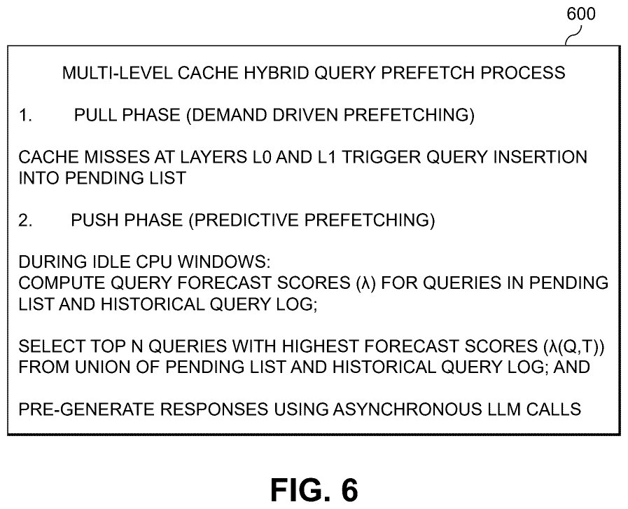

In one or more embodiments, the multi-level cache hybrid query prefetch module 118 may perform demand driven prefetching and/or predictive prefetching of queries based at least in part on forecast scores computed for queries, as discussed further below in conjunction with FIG. 6, for example. The prefetched queries may be cached, for example, in a level two cache of the multi-level query/response cache 114, and associated query responses may be retrieved in response to identifying a matching prefetched query in the multi-level query/response cache 114, as discussed further below in conjunction with FIG. 3, for example.

If a response to the new query is not found in any level of the multi-level query/response cache 114, the LLM workflow engine 110 may initiate an evaluation of the new query by one or more of the language models 116, as discussed further below in conjunction with FIG. 3, for example.

It is to be appreciated that this particular arrangement of elements 110, 112, 114, 116 and/or 118 illustrated in the adaptive multi-level caching engine 105 of the FIG. 1 embodiment is presented by way of example only, and alternative arrangements can be used in other embodiments. For example, the functionality associated with the elements 110, 112, 114, 116 and/or 118 in other embodiments can be combined into a single module, or separated across a larger number of modules. As another example, multiple distinct processors can be used to implement different ones of the elements 110, 112, 114, 116 and/or 118 or portions thereof.

At least portions of elements 110, 112, 114, 116 and/or 118 may be implemented at least in part in the form of software that is stored in memory and executed by a processor.

Additionally, the database system 106 may comprise one or more databases, such as language model data 107 comprising data pertaining to, for example, historical queries, input queries, query embeddings, query token count data, query similarity score data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The language model data 107 may be configured to store data, for example, in tables, in a known manner. While the database system 106 is illustrated in FIG. 1 as a single database, at least portions of the database system 106 may be implemented as multiple distinct databases. Example database system 106, such as depicted in the present embodiment, can be implemented using one or more storage systems associated with the adaptive multi-level caching engine 105. Such storage systems can comprise any of a variety of different types of storage including network-attached storage (NAS), storage area networks (SANs), direct-attached storage (DAS) and distributed DAS, as well as combinations of these and other storage types, including software-defined storage.

At least one embodiment includes obtaining and/or intercepting a user prompt and/or query (after submission via at least one of user devices 102, for example) and verifying if the prompt and/or query has already been submitted using the adaptive multi-level caching engine 105, as discussed herein. If the prompt and/or query is determined to be sufficiently different from the previously submitted historical prompts and/or queries, one or more embodiments can include processing the prompt and/or query to determine a query response.

Also associated with the adaptive multi-level caching engine 105 are one or more input-output devices, which illustratively comprise keyboards, displays or other types of input-output devices in any combination. Such input-output devices can be used, for example, to support one or more user interfaces to the adaptive multi-level caching engine 105, as well as to support communication between adaptive multi-level caching engine 105 and other related systems and devices not explicitly shown.

Additionally, the adaptive multi-level caching engine 105 in the FIG. 1 embodiment is assumed to be implemented using at least one processing device. Each such processing device generally comprises at least one processor and an associated memory, and implements one or more functional modules for controlling certain features of the adaptive multi-level caching engine 105.

More particularly, the adaptive multi-level caching engine 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the adaptive multi-level caching engine 105 to communicate over the network 104 with the user devices 102, and illustratively comprises one or more conventional transceivers.

It is to be understood that the particular set of elements shown in FIG. 1 for the adaptive multi-level caching engine 105 involving user devices 102 of information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the adaptive multi-level caching engine 105 and at least portions of the database system 106 can be on and/or part of the same processing platform.

In one or more embodiments, the adaptive multi-level caching engine 105 may be configured to cache a query (e.g., a request or prompt) and a corresponding query response (e.g., generated by a given language model). More particularly, after generating a vector of the query, the vector may be hashed in some embodiments to create a unique identifier for querying the adaptive multi-level caching engine 105 to check and/or determine if the same query was processed previously and cached in the level zero cache. If the unique identifier is found in the level zero cache of the multi-level query/response cache 114, the corresponding query response can be retrieved from the multi-level query/response cache 114 and returned, thus eliminating the need to process the query using a language model, which can improve the performance and reduce the cost of the language models. A hash can be generated from a query vector by importing a hashing function, quantizing the vector, converting the vector to bytes, and creating a hash of at least a portion of the bytes.

In one or more embodiments, data to be cached in the multi-level query/response cache 114 can include, e.g., the hash created of the vector of the query, search domain identifying information (e.g., user, role, program and/or chatbot identifier (ID)), the entire vector of the query as generated from vectorization, the token size of the query, and the response from the language model.

In some embodiments, if a search of the level zero cache of the multi-level query/response cache 114 (e.g., based on a query hash) does not turn up a match, indicating that an exact (or substantially exact) match is not stored in the level zero cache of the multi-level query/response cache 114, the adaptive multi-level caching engine 105 can return previous responses associated with one or more similar previous queries from the level one cache of the multi-level query/response cache 114. Similarity search algorithms such as, e.g., cosine similarity, Euclidian distance, etc., can be applied in some embodiments on cache data along with the current query being asked to evaluate similarity scores.

If a search of the level one cache of the multi-level query/response cache 114 does not identify any similar previous queries, one or more prefetched queries cached, for example, in the level two cache of the multi-level query/response cache 114 may be evaluated. If a similar prefetched query is identified, an associated query response may be retrieved and used to generate a query response to the new query. A call to a language model is only made in the event that a similar prefetched query is not identified.

By way merely of example, in connection with text analysis, one or more embodiments can include using cosine similarity to compare the orientation of two text documents as vectors in a multi-dimensional space. By calculating the cosine of the angle between these two vectors, such an embodiment can include deriving a similarity score (e.g., a score ranging from −1 to 1, wherein 1 indicates that the vectors are perfectly aligned (indicating identical direction and maximum similarity), 0 indicates orthogonality (i.e., no similarity), and −1 represents completely opposite directions). In such an embodiment, a score closer to 1 indicates a high degree of similarity and a score closer to 0 indicates dissimilarity.

Any query to a language model can be broken up into tokens during encoding, and relevant token count rules may be applied to each language model. By way merely of example, tokens can represent words and/or other characters (such as commas) in the query. Also, language models can often support different token count limits.

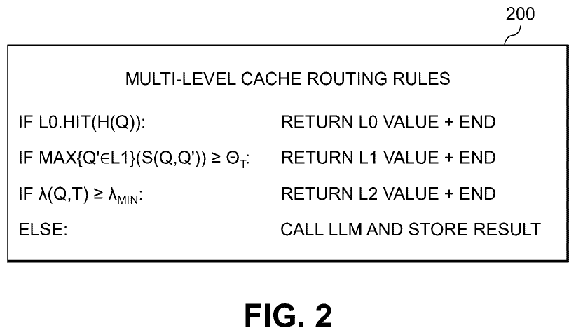

FIG. 2 illustrates exemplary routing rules 200 for a multi-level cache in accordance with an illustrative embodiment. Let Q be an incoming query string having an arrival timestamp, T. Assume that the multi-level query/response cache 114 comprises a level zero cache, L0 (e.g., an exact match cache); a level one cache, L1 (e.g., a semantic vector-based similarity cache) and a level two cache, L2 (e.g., a predictive preemptive cache).

In the example of FIG. 2, the routing rules 200 initially determine if an incoming query is found in the L0 cache, by evaluating, for example, a hash value determined using a cryptographic hash function, such as the SHA-256 cryptographic hash function from the Secure Hash Algorithm 2 (SHA-2) family. The SHA-256 cryptographic hash function takes any input data and generates a 256-bit hash value. If the incoming query is found in the L0 cache, the cached response is returned to the user.

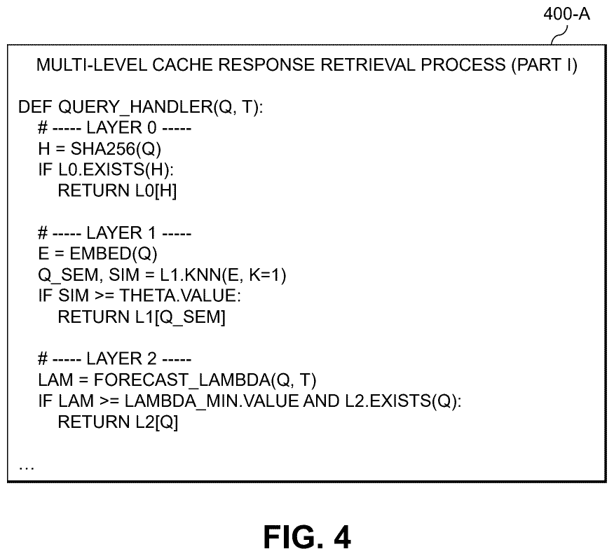

If the incoming query is not found in the L0 cache, the routing rules 200 determine if the incoming query is found in the L1 cache, by evaluating, for example, a similarity of embeddings (e.g., Bidirectional Encoder Representations from Transformers (BERT) embeddings and/or General Text embeddings (GTE)) of the incoming query to embeddings of the queries stored in the L1 cache. A Cosine similarity evaluation, for example, may be employed, as discussed further below in conjunction with FIG. 4. If the incoming query is found in the L1 cache, the cached response is returned to the user.

If the incoming query is not found in the L1 cache, the routing rules 200 determine if the incoming query is found in the L2 cache (e.g., a predictive preemptive cache), by evaluating, for example, a Poisson-rate forecast of future query arrivals for the L2 cache, as discussed further below in conjunction with FIG. 4. If the incoming query is found in the L2 cache, the cached response is returned to the user.

If the incoming query is not found in the L2 cache, the routing rules 200 call an LLM to determine a response to the incoming query, and optionally store the result in the multi-level query/response cache 114.

FIG. 3 is a flow diagram illustrating an exemplary implementation of a process for multi-level caching of language model queries in accordance with an illustrative embodiment. Generally, the process of FIG. 3 starts at the top level of the multi-level query/response cache 114 and continues to move to a lower level until a cache hit is observed. If a cache hit is not found in the lowest level cache (e.g., L2), then an LLM is called (e.g., as a last resort).

In the example of FIG. 3, an incoming query 305 is obtained and a test is performed in step 315 to determine if the incoming query 305 matches a query cached in the level zero cache of the multi-level cache. If it is determined in step 315 that the incoming query 305 matches a query cached in the level zero cache, then a response is returned in step 320 from the level zero cache.

If it is determined in step 315 that the incoming query 305 does not match a query cached in the level zero cache, then a further test is performed in step 325 to determine if the incoming query 305 has a similarity score with a query cached in the level one cache of the multi-level cache satisfying one or more designated similarity criteria (e.g., a similarity score above a designated threshold).

If it is determined in step 325 that the incoming query 305 has a similarity score with a query cached in the level one cache, then a response is returned in step 330 from the level one cache.

If it is determined in step 325 that the incoming query 305 does not have a similarity score with a query cached in the level one cache, then a further test is performed in step 335 to determine if the incoming query 305 matches a prefetched query in the level two cache of the multi-level cache. If it is determined in step 335 that the incoming query 305 matches a prefetched query in the level two cache, then a response is returned in step 340 from the level two cache.

If it is determined in step 335 that the incoming query 305 does not match a prefetched query in the level two cache, then an LLM is called in step 350 to generate a response to the incoming query 305. The generated response to the incoming query 305 is then stored in a selected level of the multi-level cache in step 355. The cache level may be selected in some embodiments based on forecast scores and/or RL-derived thresholds. When an LLM call is made (e.g., in step 350 of FIG. 3), the response is stored in a “selected level” of the multi-level cache (e.g., in step 355), which may be dynamically selected based on a likelihood of reuse (e.g., a frequency score, a similarity potential and/or a forecasted demand).

The returned responses from steps 320, 330 or 340, or the generated response from step 350 is then served to the user in step 375.

As also shown in FIG. 3 an RL controller 370 (e.g., the RL controller 112 of FIG. 1) provides RL feedback that may comprise, for example, a resource allocation among the multiple levels of the multi-level query/response cache 114, cache entry expiry information, similarity thresholds (e.g., for the L1 and L2 caches) and/or a forecast precision for the L2 cache.

FIG. 4 is a process diagram illustrating an exemplary implementation of a first portion of a process 400-A for multi-level cache response retrieval in accordance with an illustrative embodiment. Let Q be an incoming query string having an arrival timestamp, T. Assume again that the multi-level query/response cache 114 comprises a level zero cache, L0 (e.g., an exact match cache); a level one cache, L1 (e.g., a semantic vector-based similarity cache) and a level two cache, L2 (e.g., a predictive preemptive cache).

In the example of FIG. 4, the process 400-A initially determines if the incoming query Q is found in the L0 cache, by evaluating, for example, a hash value determined using a cryptographic hash function (e.g., the SHA-256 cryptographic hash function) If the incoming query is found in the L0 cache, the cached response is returned by the process 400-A to the user.

If the incoming query is not found in the L0 cache, the process 400-A determines if the incoming query is found in the L1 cache, by evaluating, for example, a similarity of embeddings of the incoming query to embeddings of the queries stored in the L1 cache. A cosine similarity evaluation, for example, may be expressed, as follows:

$$S ( Q , {Q}^{′} ) = \frac{e ( Q ) e ( {Q}^{′} )}{‖ e ( Q ) ‖ ‖ e ( {Q}^{′} ) ‖} ,$$

where a similarity threshold Or for the similarity evaluation may be adapted by the RL controller 112. The embeddings may be expressed as E∈ [symbol] . If the incoming query is found in the L1 cache, the cached response is returned by the process 400-A to the user.

If the incoming query is not found in the L1 cache, the process 400-A determines if the incoming query is found in the L2 cache (e.g., a predictive preemptive cache), by evaluating, for example, a Poisson-rate forecast of future query arrivals for the L2 cache. For example, the forecast score for the predictive cache (e.g., the L2 cache), may be expressed, as follows:

λ(Q,T)=Pᵣₑᵤₛₑ(Q)×(1−σ_{U}(Q)); and

Pᵣₑᵤₛₑ(Q)=1−exp(−Ñ(Q)),
where Pᵣₑᵤₛₑ is a probability of reuse (e.g., that a given query will be repeated) and a similarity threshold λ_{MIN} for the similarity evaluation λ(Q,T) may be adapted by the RL controller 112, as discussed further below. Entries with λ≥λ_{MIN} are prefetched into the L2 cache during quiet cycles. If an incoming query is found in the L2 cache, the cached response is returned by the process 400-A to the user.

FIG. 5 is a process diagram illustrating an exemplary implementation of a second portion of the process 400-B for multi-level cache response retrieval in accordance with an illustrative embodiment. In the example of FIG. 5, if the incoming query was not found in the L0, L1 or L2 cache by the first portion of the process 400-A of FIG. 4, the process 400-B of FIG. 5 calls an LLM to determine a response to the incoming query and optionally store the result in the multi-level query/response cache 114.

The RL controller 370 of FIG. 3 may operate in accordance with the bottom portion of FIG. 5 to process (i) a state comprising cache metrics (e.g., a utilization metric for one or more levels of the multi-level cache, a cache hit rate ratio and/or at least one threshold for evaluating a similarity metric (e.g., in the L1 cache) and a forecast score (e.g., in the L2 cache), and (ii) a reward based on a change in the cache hit rate ratio, a ratio of a number of language model calls to a total number of queries and a ratio of a number of cache evictions to a capacity of the multi-level cache. The RL controller 370 selects at least one action, such as an adjustment to one or more of the utilization metrics for each level of the multi-level cache and the at least one threshold.

In some embodiments, the RL state, S(T), may be expressed, as follows:

S(T)=(u₀,u₁,u₂,HR,Θ_{T},λₘᵢₙ),
where uᵢ indicates the utilization ratio of a given level, HR indicates the cache hit rate (e.g., in the last interval), θₜ, is a current similarity threshold and λₘᵢₙ is a current minimum forecast score.

The available RL actions, a_{T}, may be expressed, as follows:

a_{T}∈(±δu₀,±δu₁,±δu₂,±δΘ,±δλ),
where δ indicates a bounded adjustment to one or more of the utilization metrics for each level of the multi-level cache or one of the thresholds (θ_{T}, λₘᵢₙ). The thresholds (θ_{T}, λₘᵢₙ) may be updated every RL cycle, for example, as follows:

$${Θ}_{T + 1} = {Θ}_{T} + {η}_{Θ} δΘ ,$$

$$and$$

$${λ}_{min}^{T + 1} = {λ}_{min}^{T} + {η}_{λ} δλ ,$$

where δθ and δλ are the chosen actions and η_{θ} and η_{λ} are per-parameter step sizes constrained so that 0.5≤θ≤0.90 and 0.01≤λₘᵢₙ≤0.5, for example.

The RL reward, R_{T}, may be expressed, as follows:

$${R}_{T} = α ( {HR}_{T} - {HR}_{T - 1} ) - β ( \frac{LLM CALLS}{QUERIES} ) - γ ( \frac{{EVICTIONS}_{T}}{CAPACITY} ) ,$$

where α, β and γ are respective weights in the RL reward function for each respective term, learned during a policy optimization (e.g., using proximal policy optimization (PPO) techniques) to improve (e.g., maximize) a cumulative reward. Thus, α adjusts the reward for improving the cache hit rate, β penalizes LLM calls relative to total queries, and γ penalizes eviction-to-capacity ratios (e.g., memory churn). This weighting structure enables the adaptive multi-level caching engine 105 to dynamically learn trade-offs between cost, latency and memory utilization under real-world query loads.

In some embodiments, the RL controller 370 updates the state, action and reward according to customizable cache policies, for example, using PPO techniques. For example, an enterprise can define cache policies, including cache size limits, expiration times, and update frequencies (e.g., to maximize hit rates), thereby allowing fine grain business controls without breaking the learning loop.

For example, when a given query, such as “reset root password” is first received, the multi-level cache (e.g., the L0 cache) will not have seen the query previously, so a cache miss will be encountered. In some embodiments, the given query will be added to a pending list of queries. An LLM will be called to generate an answer (e.g., in step 350 of FIG. 3). The reward will penalize the LLM call, and the response will be stored in the multi-level cache (e.g., in the L1 cache). If the same user then queries “how to change root password” five minutes later, there will be a cache hit (e.g., having a similarity score of 0.92) in the L1 cache (increasing the cache hit rate and having an associated positive reward). If a surge in firmware queries is then detected the RL controller 370 may raise the L2 allocation and lower the λₘᵢₙ threshold (further increasing the cache hit rate and having an associated positive reward).

FIG. 6 is a process diagram illustrating an exemplary implementation of a multi-level cache hybrid query prefetch process 600 in accordance with an illustrative embodiment. The level two cache may retrieve previous queries using a similarity search and may employ hybrid prefetching strategies that combine demand-driven prefetching and predictive prefetching (e.g., to optimize cache loading for various scenarios).

In the example of FIG. 6, the demand-driven prefetching comprises adding queries that experience cache misses in the L0/L1 cache levels into the pending list of queries, for example, in a pull phase. The predictive prefetching comprises (e.g., during idle CPU windows, based on one or more designated idle criteria) (i) computing query forecast scores (λ) for queries in the pending list and in a historical query log; (ii) selecting, for example, the top N queries having the highest forecast scores (λ(Q,t)) from a union of the pending list and the historical query log; and (iii) pre-generating responses to such Top N queries using asynchronous LLM calls (which may be populated in the L2 cache, for example).

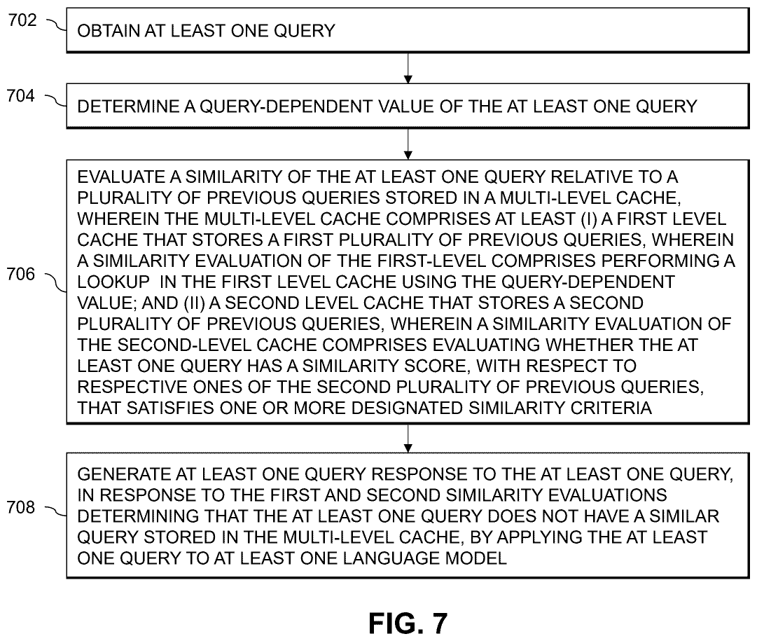

FIG. 7 is a flow diagram illustrating an exemplary implementation of a process for multi-level caching of language model queries in accordance with an illustrative embodiment. In the example of FIG. 7, at least one query is obtained in step 702. A query-dependent value of the at least one query is determined in step 704. As used herein, the term “query-dependent value” shall be broadly construed to encompass, for example, hash values and other query representations, such as string normalization, canonicalization and/or fingerprinting that achieve functionally equivalent exact-matching behavior, as would be apparent to a person of ordinary skill in the art.

A similarity of the at least one query relative to a plurality of previous queries stored in a multi-level cache is evaluated in step 706, wherein the multi-level cache comprises at least (i) a first level cache that stores a first plurality of previous queries, wherein a first similarity evaluation of the first-level cache comprises performing a lookup in the first level cache using the query-dependent value and (ii) a second level cache that stores a second plurality of previous queries, wherein a second similarity evaluation of the second-level cache comprises evaluating whether the at least one query has a similarity score, with respect to respective ones of the second plurality of previous queries, that satisfies one or more designated similarity criteria.

The term “cache,” as used herein, shall be broadly construed to encompass any processor-readable storage media including, without limitation, a storage array, a storage drive, including SSDs, or an integrated circuit comprising RAM, ROM or other electronic memory, or combinations thereof, in any configuration, including caches having multiple tiers and/or multiple levels, as well as distributed caches, or any of a wide variety of other types of storage products, as would be apparent to a person of ordinary skill in the art.

At least one query response to the at least one query is generated in step 708, in response to the first and second similarity evaluations determining that the at least one query does not have a similar query in the multi-level cache, by applying the at least one query to at least one language model. The at least one query response may be generated by reusing the value (e.g., the prior response) associated with the matched query and can be served directly from the level zero cache.

In one or more embodiments, the process of FIG. 7 may further comprise, in response to the lookup determining that the at least one query matches a given one of the first plurality of previous queries stored in the first level cache of the multi-level cache, generating at least one query response to the at least one query by processing a query response associated with the given previous query, wherein the first level cache stores a plurality of frequent queries, based at least in part on one or more designated frequency criteria.

In addition, the process of FIG. 7 may further comprise, in response to determining that the at least one query has the similarity score with respect to a given one of the second plurality of previous queries stored in the second level cache, that satisfies the one or more designated similarity criteria, generating at least one query response to the at least one query by processing a query response associated with the given previous query wherein the second level cache stores a plurality of previous queries indexed by respective semantic embeddings.

In some embodiments, the at least one query response is stored in a selected level of the multi-level cache. The process of FIG. 7 may further comprise performing at least one action with respect to the multi-level cache, wherein the at least one action is selected, at least in part, by at least one processor-based reinforcement learning model that evaluates (i) a state comprising one or more of a utilization metric for each level of the multi-level cache, a cache hit rate ratio and at least one threshold for evaluating one or more of a similarity metric and a forecast score, and (ii) a reward based at least in part on one or more of a change in the cache hit rate ratio, a ratio of a number of language model calls to a total number of queries and a ratio of a number of cache evictions to a capacity of the multi-level cache, wherein the at least one action comprises one or more of an adjustment to one or more of the utilization metric for each level of the multi-level cache and the at least one threshold.

In at least one embodiment, the process of FIG. 7 may further comprise, in response to determining that the at least one query does not have a similarity score, with respect to a given one of a third plurality of previous queries stored in a third level cache of the multi-level cache, that satisfies the one or more designated similarity criteria, generating at least one query response to the at least one query by processing a query response associated with the given previous query, wherein the third level cache stores a plurality of predicted queries. In response to one or more compute metrics satisfying one or more designated idle criteria, the process of FIG. 7 may (i) select a set of identified queries based at least in part on a forecast score assigned to each identified query and (ii) generate at least one query response to at least one identified query in the set by applying the at least one identified query to at least one language model, wherein the set of identified queries is identified based at least in part on one or more of at least one previous query not being found in the multi-level cache and a likelihood of reuse of one or more previous queries.

The particular processing operations and other network functionality described in conjunction with FIGS. 3 through 7, for example, are presented by way of illustrative example only, and should not be construed as limiting the scope of the disclosure in any way. Alternative embodiments can use other types of processing operations for multi-level caching of language model queries. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Among other benefits, the disclosed multi-level caching techniques unifies exact match, semantic and/or forecasted reuse along with an RL controller 112 that dynamically tunes thresholds, memory quotas and prefetch budgets. It can be shown that the disclosed multi-level caching techniques exhibit 80% fewer LLM calls and a faster response time (e.g., below 10 ms) for repeated queries.

The disclosed multi-level caching techniques may provide (i) reduced token usage (e.g., by categorizing queries and caching preemptively, the system reduces redundant LLM calls (and the associated token generation) by up to 80%; (ii) improved response times (e.g., improving response times by a factor of approximately 200, thereby reducing (e.g., minimizing) latency; (iii) real-time adaptation (e.g., the self-optimization RL mechanism ensures that caching strategies evolve in real-time based on actual system usage; and (iv) business flexibility (e.g., customizable policies allow businesses to tailor the multi-level query/response cache 114 to their specific operational needs).

Consider a customer service chatbot in an e-commerce platform, for example. Frequently asked questions may be stored in the L0 cache (e.g., an in-memory exact match cache), while variations of common questions may be handled by the L1 cache (e.g., a semantic vector-based cache). Anticipated queries, such as those related to upcoming sales, may be preemptively cached in the L2 cache (e.g., a predictive preemptive cache), ensuring rapid responses.

One or more embodiments of the disclosure provide improved methods, apparatus and computer program products for multi-level caching of language model queries. The foregoing applications and associated embodiments should be considered as illustrative only, and numerous other embodiments can be configured using the techniques disclosed herein, in a wide variety of different applications.

It should also be understood that the disclosed techniques for multi-level caching of language model queries, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for multi-level caching of language model queries may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based multi-level caching engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based multi-level caching platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

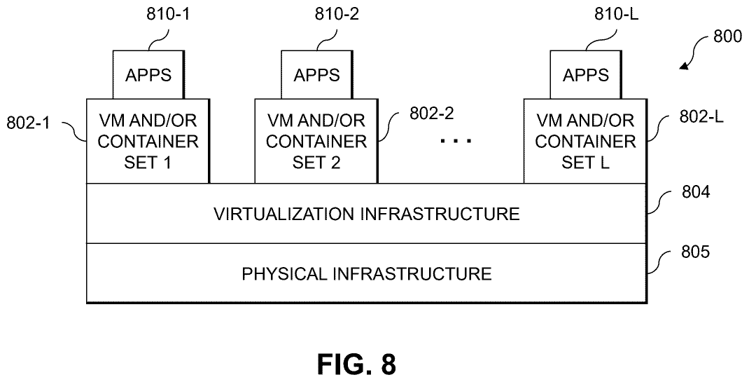

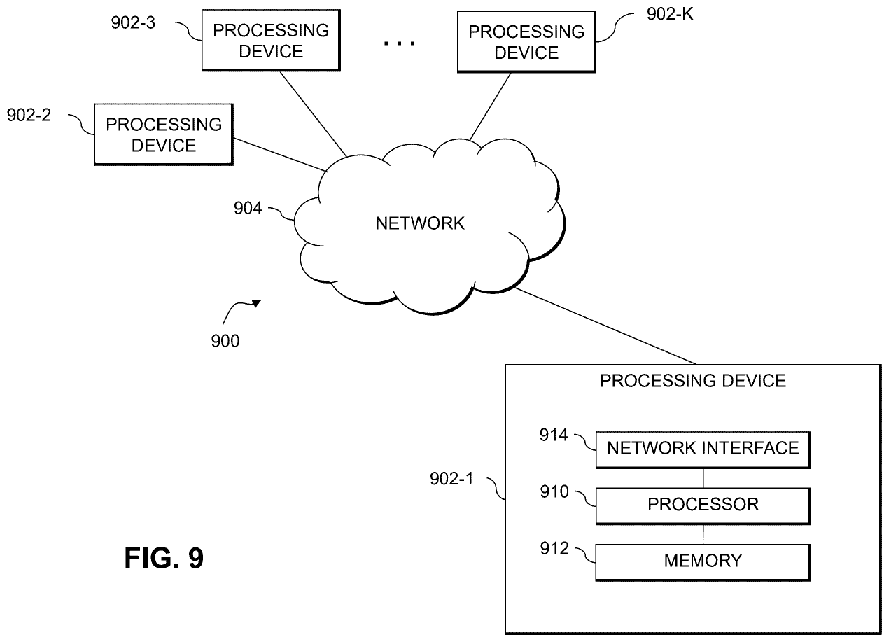

Illustrative embodiments of processing platforms will now be described in greater detail with reference to FIGS. 8 and 9. These platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. Such implementations can provide multi-level caching functionality of the type described above for one or more processes running on a given one of the VMs. For example, each of the VMs can implement control logic for multi-level caching and associated functionality for generating query responses using at least one language model, when needed.

An example of a hypervisor platform that may be used to implement a hypervisor within the virtualization infrastructure 804 is a compute virtualization platform which may have an associated virtual infrastructure management system such as server management software. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system. Such implementations can provide multi-level caching functionality of the type described above for one or more processes running on different ones of the containers. For example, a container host device supporting multiple containers of one or more container sets can implement one or more instances of control logic for multi-level caching and associated functionality for generating query responses using at least one language model, when needed.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises at least a portion of the given system and includes a plurality of processing devices, denoted 902-1, 902-2, 902-3, . . . 902-K, which communicate with one another over a network 904. The network 904 may comprise any type of network, such as a WAN, a LAN, a satellite network, a telephone or cable network, a cellular network, a wireless network such as WiFi or WiMAX, or various portions or combinations of these and other types of networks.

The processing device 902-1 in the processing platform 900 comprises a processor 910 coupled to a memory 912. The processor 910 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 912, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 8 or 9, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A method, comprising:
obtaining at least one query;
determining a query-dependent value of the at least one query, wherein the determining comprises applying at least one function to a vector representation of the at least one query to obtain the query-dependent value;
evaluating a similarity of the at least one query relative to a plurality of previous queries stored in a multi-level cache, wherein the multi-level cache comprises at least (i) a first level cache that stores a first plurality of previous queries, wherein a first similarity evaluation of the first-level cache comprises performing a lookup in the first level cache using the query-dependent value as a key lookup; and (ii) a second level cache that stores a second plurality of previous queries, wherein a second similarity evaluation of the second-level cache comprises evaluating whether the at least one query has a similarity score, with respect to respective ones of the second plurality of previous queries, that satisfies one or more designated similarity criteria; and
generating at least one query response to the at least one query, in response to the first and second similarity evaluations determining that the at least one query does not have a similar query stored in the multi-level cache, by applying the at least one query to at least one language model;
wherein the method is performed by at least one processing device comprising a processor coupled to a memory.

2. The method of claim 1, further comprising, in response to the lookup determining that the at least one query matches a given one of the first plurality of previous queries stored in the first level cache of the multi-level cache, generating at least one query response to the at least one query by processing a query response associated with the given previous query, wherein the first level cache stores a plurality of frequent queries, based at least in part on one or more designated frequency criteria.

3. The method of claim 1, further comprising, in response to determining that the at least one query has the similarity score with respect to a given one of the second plurality of previous queries stored in the second level cache, that satisfies the one or more designated similarity criteria, generating at least one query response to the at least one query by processing a query response associated with the given previous query, wherein the second level cache stores a plurality of previous queries indexed by respective semantic embeddings.

4. The method of claim 1, further comprising storing the at least one query response in a selected level of the multi-level cache.

5. The method of claim 1, further comprising, in response to determining that the at least one query has a similarity score, with respect to at least a given one of a third plurality of previous queries stored in a third level cache of the multi-level cache, that satisfies one or more designated similarity criteria, generating at least one query response to the at least one query by processing a query response associated with the given previous query, wherein the third level cache stores a plurality of predicted queries.

6. The method of claim 5, further comprising, in response to one or more compute metrics satisfying one or more designated idle criteria, (i) selecting a set of identified queries based at least in part on a forecast score assigned to each identified query and (ii) generating at least one query response to at least one identified query in the set by applying the at least one identified query to at least one language model, wherein the set of identified queries is identified based at least in part on one or more of at least one previous query not being found in the multi-level cache and a likelihood of reuse of one or more previous queries.

7. The method of claim 1, further comprising performing at least one action with respect to the multi-level cache, wherein the at least one action is selected, at least in part, by at least one processor-based reinforcement learning model that evaluates (i) a state comprising one or more of a utilization metric for each level of the multi-level cache, a cache hit rate ratio and at least one threshold for evaluating one or more of a similarity metric and a forecast score, and (ii) a reward based at least in part on one or more of a change in the cache hit rate ratio, a ratio of a number of language model calls to a total number of queries and a ratio of a number of cache evictions to a capacity of the multi-level cache, wherein the at least one action comprises one or more of an adjustment to one or more of the utilization metric for each level of the multi-level cache and the at least one threshold.

8. An apparatus comprising:
at least one processing device comprising a processor coupled to a memory;
the at least one processing device being configured to implement the following steps:
obtaining at least one query;
determining a query-dependent value of the at least one query, wherein the determining comprises applying at least one function to a vector representation of the at least one query to obtain the query-dependent value;
evaluating a similarity of the at least one query relative to a plurality of previous queries stored in a multi-level cache, wherein the multi-level cache comprises at least (i) a first level cache that stores a first plurality of previous queries, wherein a first similarity evaluation of the first-level cache comprises performing a lookup in the first level cache using the query-dependent value as a key lookup; and (ii) a second level cache that stores a second plurality of previous queries, wherein a second similarity evaluation of the second-level cache comprises evaluating whether the at least one query has a similarity score, with respect to respective ones of the second plurality of previous queries, that satisfies one or more designated similarity criteria; and
generating at least one query response to the at least one query, in response to the first and second similarity evaluations determining that the at least one query does not have a similar query stored in the multi-level cache, by applying the at least one query to at least one language model.

9. The apparatus of claim 8, further comprising, in response to the lookup determining that the at least one query matches a given one of the first plurality of previous queries stored in the first level cache of the multi-level cache, generating at least one query response to the at least one query by processing a query response associated with the given previous query, wherein the first level cache stores a plurality of frequent queries, based at least in part on one or more designated frequency criteria.

10. The apparatus of claim 8, further comprising, in response to determining that the at least one query has the similarity score with respect to a given one of the second plurality of previous queries stored in the second level cache, that satisfies the one or more designated similarity criteria, generating at least one query response to the at least one query by processing a query response associated with the given previous query, wherein the second level cache stores a plurality of previous queries indexed by respective semantic embeddings.

11. The apparatus of claim 8, further comprising storing the at least one query response in a selected level of the multi-level cache.

12. The apparatus of claim 8, further comprising, in response to determining that the at least one query has a similarity score, with respect to at least a given one of a third plurality of previous queries stored in a third level cache of the multi-level cache, that satisfies one or more designated similarity criteria, generating at least one query response to the at least one query by processing a query response associated with the given previous query, wherein the third level cache stores a plurality of predicted queries.

13. The apparatus of claim 12, further comprising, in response to one or more compute metrics satisfying one or more designated idle criteria, (i) selecting a set of identified queries based at least in part on a forecast score assigned to each identified query and (ii) generating at least one query response to at least one identified query in the set by applying the at least one identified query to at least one language model, wherein the set of identified queries is identified based at least in part on one or more of at least one previous query not being found in the multi-level cache and a likelihood of reuse of one or more previous queries.

14. The apparatus of claim 8, further comprising performing at least one action with respect to the multi-level cache, wherein the at least one action is selected, at least in part, by at least one processor-based reinforcement learning model that evaluates (i) a state comprising one or more of a utilization metric for each level of the multi-level cache, a cache hit rate ratio and at least one threshold for evaluating one or more of a similarity metric and a forecast score, and (ii) a reward based at least in part on one or more of a change in the cache hit rate ratio, a ratio of a number of language model calls to a total number of queries and a ratio of a number of cache evictions to a capacity of the multi-level cache, wherein the at least one action comprises one or more of an adjustment to one or more of the utilization metric for each level of the multi-level cache and the at least one threshold.

15. A non-transitory processor-readable storage medium having stored therein program code of one or more software programs, wherein the program code when executed by at least one processing device causes the at least one processing device to perform the following steps:
obtaining at least one query;
determining a query-dependent value of the at least one query, wherein the determining comprises applying at least one function to a vector representation of the at least one query to obtain the query-dependent value;
evaluating a similarity of the at least one query relative to a plurality of previous queries stored in a multi-level cache, wherein the multi-level cache comprises at least (i) a first level cache that stores a first plurality of previous queries, wherein a first similarity evaluation of the first-level cache comprises performing a lookup in the first level cache using the query-dependent value as a key lookup; and (ii) a second level cache that stores a second plurality of previous queries, wherein a second similarity evaluation of the second-level cache comprises evaluating whether the at least one query has a similarity score, with respect to respective ones of the second plurality of previous queries, that satisfies one or more designated similarity criteria; and
generating at least one query response to the at least one query, in response to the first and second similarity evaluations determining that the at least one query does not have a similar query stored in the multi-level cache, by applying the at least one query to at least one language model.

16. The non-transitory processor-readable storage medium of claim 15, further comprising, in response to the lookup determining that the at least one query matches a given one of the first plurality of previous queries stored in the first level cache of the multi-level cache, generating at least one query response to the at least one query by processing a query response associated with the given previous query, wherein the first level cache stores a plurality of frequent queries, based at least in part on one or more designated frequency criteria.

17. The non-transitory processor-readable storage medium of claim 15, further comprising, in response to determining that the at least one query has the similarity score with respect to a given one of the second plurality of previous queries stored in the second level cache, that satisfies the one or more designated similarity criteria, generating at least one query response to the at least one query by processing a query response associated with the given previous query, wherein the second level cache stores a plurality of previous queries indexed by respective semantic embeddings.

18. The non-transitory processor-readable storage medium of claim 15, further comprising storing the at least one query response in a selected level of the multi-level cache.

19. The non-transitory processor-readable storage medium of claim 15, further comprising, in response to determining that the at least one query has a similarity score, with respect to at least a given one of a third plurality of previous queries stored in a third level cache of the multi-level cache, that satisfies one or more designated similarity criteria, generating at least one query response to the at least one query by processing a query response associated with the given previous query, wherein the third level cache stores a plurality of predicted queries.

20. The non-transitory processor-readable storage medium of claim 15, further comprising performing at least one action with respect to the multi-level cache, wherein the at least one action is selected, at least in part, by at least one processor-based reinforcement learning model that evaluates (i) a state comprising one or more of a utilization metric for each level of the multi-level cache, a cache hit rate ratio and at least one threshold for evaluating one or more of a similarity metric and a forecast score, and (ii) a reward based at least in part on one or more of a change in the cache hit rate ratio, a ratio of a number of language model calls to a total number of queries and a ratio of a number of cache evictions to a capacity of the multi-level cache, wherein the at least one action comprises one or more of an adjustment to one or more of the utilization metric for each level of the multi-level cache and the at least one threshold.
